(19) United States
(12) Patent Application Publication
(10) Pub. No.: US 2015/0185966 A1
(43) Pub. Date: Jul. 2, 2015

(54) SPONTANEOUS GROUPS LEARNING SYSTEM

(71) Applicant: Ilya Osipov, San Francisco, CA (US)

(72) Inventor: Ilya Osipov, San Francisco, CA (US)

(21) Appl. No.: 14/546,609

(22) Filed: Nov. 18, 2014

Related U.S. Application Data
(60) Provisional application No. 61/922,108, filed on Dec. 31, 2013.

(51) Int. Cl. G06F 3/0481; G06F 3/0484; H04L 12/18

(52) U.S. Cl. CPC G06F 3/0481; H04L 12/1822; G06F 3/04842

(57) ABSTRACT

Users may form learning groups in real time on-line by choosing among pre-defined participant roles in a group, e.g. “a teacher” or a “student”, reviewing the list of available participants, sending invitations, reviewing pending invitations with role descriptions, and accepting the invitations. Learning groups may be formed by two or more participants, and do not require advance scheduling or determination of the group composition. Teaching may be delivered in the form of pre-set scenario on topics, wherein the content is deliverd in differentiated formats to teachers and students, with an option of activated tips for the students in their native language.

This application claims the benefit of U.S. Provisional Application 61/922,108, filed Dec. 31, 2014.

### BACKGROUND

On-line educational services currently available to the public wishing to learn foreign languages broadly fall into two categories: autonomous and social. Autonomous methods offer tasks which are checked or monitored in accordance with the algorithms set up within the system (tests, quizzes, etc.).

Social methods allow direct or indirect interaction with real people to complete functions indispensible for learning a language including but not limited to unscripted communication, checking assignments, and providing real-time feedback on mastery of learned skills. The social learning systems delivering educational services rely on scheduling study sessions between a teacher and a student, a teacher and a group or students, or among a peer group of students. Scheduling for multiple individuals, often located far geographically and across multiple time zones, may present considerable challenges, requires time and effort.

These difficulties may reflect negatively on students' motivation, retention and learning outcomes. For commercial providers supporting such learning systems, these difficulties result in reduced revenue. Individuals acting as teachers experience reduced satisfaction and reduced compensation, when teaching for money.

Modern-day users expect services to be available on demand without unnecessary time constraints, similar to their experiences with on-line shopping and on-line scheduling of other services. Scheduling-based systems fail to provide learning experience on par with these expectations.

### SUMMARY

A spontaneous group learning system consistent with the present description includes a computer-readable storage medium including a program code encoded therein, wherein the program code is configured to be executed by a processor, the program code includes a plurality of executable instructions for teaching a subject matter, and the executable instructions include: forming a first user connector interface, including a field enabling the first user to select a first participant role; forming a second user connector interface, including a field enabling a second user to select a second participant role; generating a field comprised within the first user connector interface indicating the second user identity and the second participant role selected by the second user; forming a spontaneous group interface accessible to the first user; enabling the first user to invite the second user to join the spontaneous group interface; indicating second user connectedness status in the spontaneous group interface; enabling the second user to generate a response chosen from the group comprising a consent or a rejection to the first user invitation, the invitation after being issued by the first user before the response is obtained being held pending; obtaining the second user consent to the first user invitation, and generating a first learning group interface accessible to the first user and a second learning group interface accessible to the second user upon obtaining the second user consent.

### BRIEF DESCRIPTION OF THE DRAWINGS

FIG. 1 is a schematic representation of a user connector interface displaying pending outgoing invitations in the user interface mode showing all pending outgoing invitations.

FIG. 2 is a schematic representation of a user connector interface displaying pending incoming invitations in two user interface modes. If multiple incoming calls, an incoming calls list opens by pressing the incoming calls icon.

FIG. 3 is a diagram illustrating a structure of a user learning interface.

FIG. 4 is a diagram illustrating delivery of the content from a slide description to information slide sections of a student user interface and of a teacher user interface.

FIG. 5 is a block diagram that illustrates an exemplary embodiment of a computer system.

### DETAILED DESCRIPTION

In one embodiment of the current disclosure, the subject matter can be a human language, e.g. English taught to non-English speakers, or sign language. In other embodiments the subject matter may include but not limited to machine languages, sciences, literary subjects, speech and presentation skills, language or speech therapy, music, crafts, art, etiquette, phonetics or accents, dance or creative movement, pantomime or sports.

### User Connector Interface

The role of the disclosed apparatus is to provide user connector interface supporting creation of spontaneous learning communities. A spontaneous learning community is defined as one consisting of at least two users (a learning pair or a learning group), who did not pre-define the composition of the learning group or the time of cooperative learning in advance.

In one embodiment of the current disclosure, the creation of learning group is facilitated by a user connector interface capable to receive information from a user and represent to him similar information from other user. In one typical configuration, the connector interface comprises fields where the user may indicate his desired role in a language learning group, e.g. “a student”, or “a teacher”, and his self-assessed level of proficiency in the language.

In some embodiments of the disclosure other roles in learning group may be defined, including but not limited to “a facilitator”, or “a group participants' performance assessor”. In all examples of participant roles, the titles defined as functionally descriptive examples. Actual connector interfaces can use custom names, functionally or creatively chosen, e.g. “mentor”, “Candid”, “adjective shark”. The choices of names may reflect, e.g. personal learning or teaching styles, speech patterns or achieved proficiency levels. The role descriptors may be self-chosen by users, or assigned by the system based on its analysis of users' record of past performance, or on questionnaires, or combination thereof, or other rule, generally designed to promote membership, or participation or improved learning outcomes or other functional attribute or value of learning experience.

In some embodiments, user connector interface may comprise a field indicating the balance of use credit. Use credit may be expressed in minutes of use, or points or money equivalent (i.e. units of national currency or bitcoin) or some other units reflecting the user access to other services

In another embodiment, the interface will obtain the proficiency level of the user from the stored record of past performance or/and assessments. In yet another embodiment, the system will set or suggest the appropriate role for the user based on comparison to self-assessed or retrieved levels of proficiency of other users participating in the group.

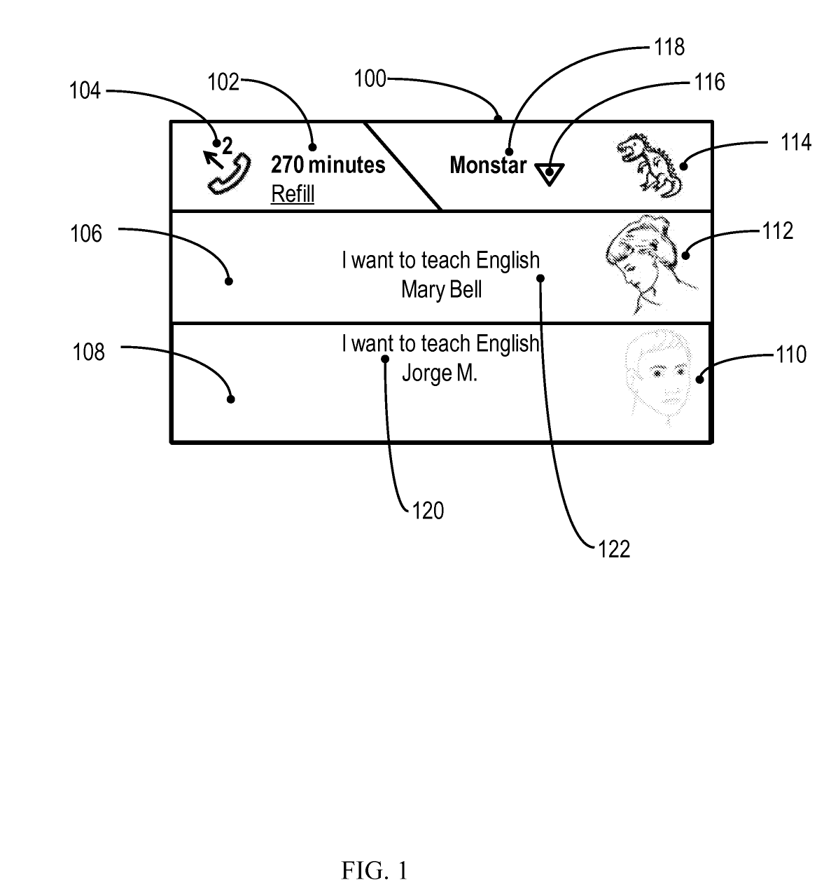

In FIG. 1, an example embodiment is shown wherein a user connector interface 100 comprises fields indicating the user identity 118 and the balance of the user's credit expressed in minutes 102.

Further, the user interface indicates that the user has placed two outgoing invitations in the pending invitations field 104. The invitation fields 106 and 108 respectively comprise textual fields 120 and 122 indicating the roles and identities of the users to whom the pending invitations had been issued,

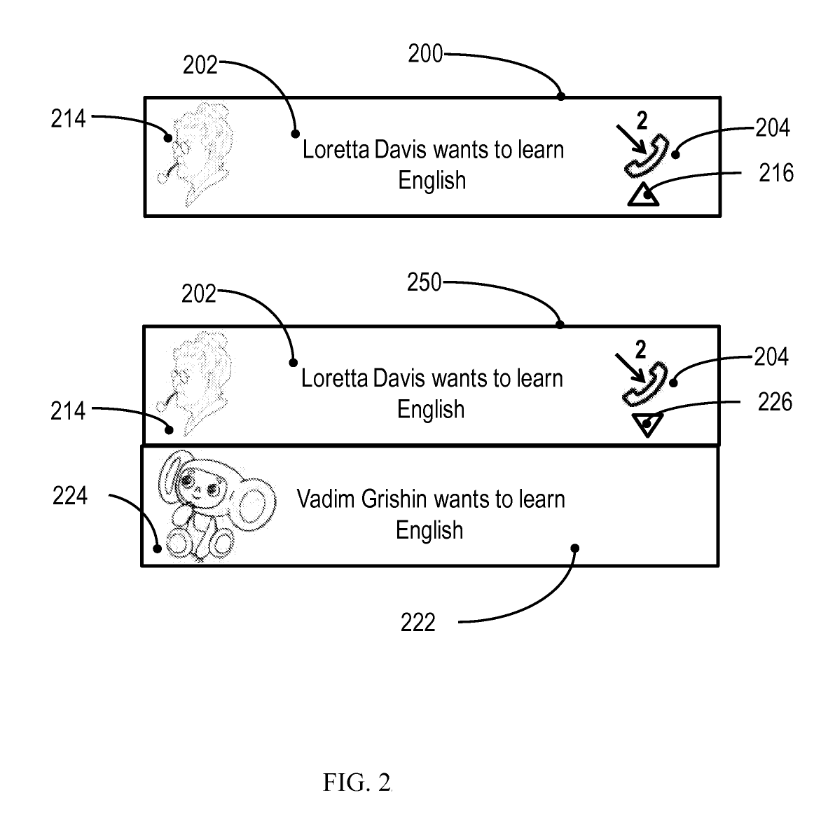

Similarly, the user interface may be configured as shown in FIG. 2 to indicate the number of pending incoming invitations in the field 204. The view switch 216 allows to toggle between the user interface mode showing only the latest pending incoming invitation 200 and the user interface mode 250 showing all pending incoming invitations 214 and 224. It is understood that the user interface indicating outgoing calls may be similarly configured to toggle between the two modes (“last placed pending invitation only” and “display all pending invitations”) by means of toggle switch 116. The toggle switch appearance changes based on its current value, e.g. as shown in FIG. 2 from triangle apex upward 216 denoting compact mode to triangle apex downward 226 denoting expanded mode.

In the example of user interface shown in FIG. 1, the user roles are indicated in invitation indicator fields 106 and 108 as “I want to teach English”, an equivalent of “teacher” role; similarly, in the examples of user interface shown in FIG. 2, the user roles are indicated as “Wants to learn English” in invitation indicator fields 214 and 224, as equivalents of “student” role.

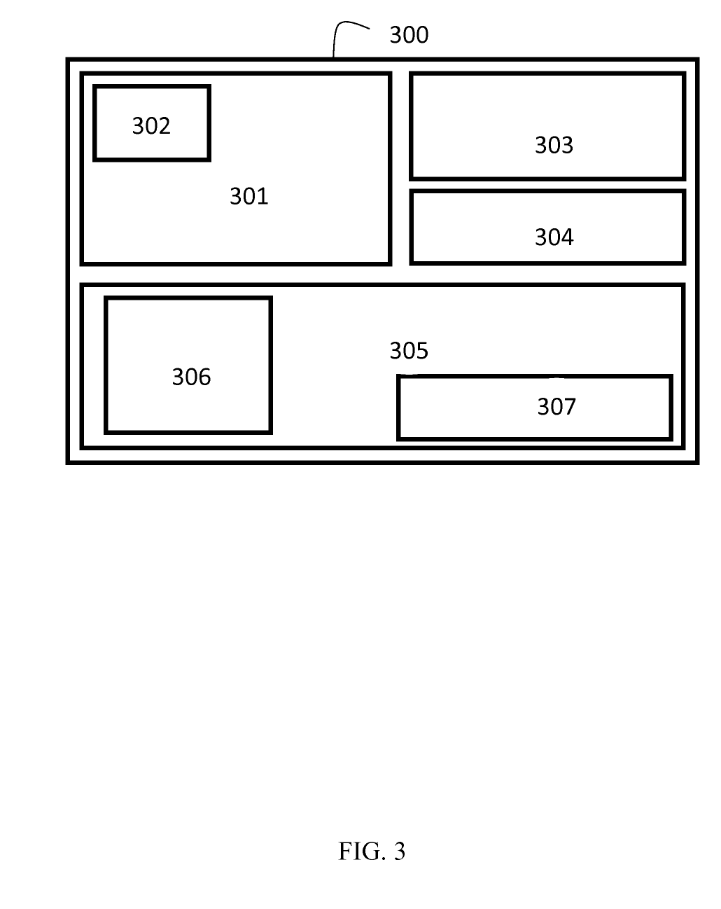

In one embodiment of the current disclosure, after a user accepts an invitation by clicking on the pending incoming invitation field in the user's interface 214 or 224, an acceptance notification window appears simultaneously on the user's screen and on the screen of the user who had issued the accepted invitation, see FIG. 3.

In one embodiment of the current disclosure, all other pending invitations directed to the user are placed on hold. Thus a learning pair is formed based not on advance scheduling, but on spontaneous decision following the invitations issued to a set of users who indicated their current availability in suitable roles.

In another embodiment, the incoming calls are not placed on hold, e.g. user acting as a teacher after accepting an invitation from a student may choose to accept another invitation from a different student, thus forming a spontaneously formed learning group with more than two participants.

In yet another embodiment, after the user acting as a teacher issues multiple invitations to students, as the students accept the incoming invitations the learning group gets expanded.

Further, the teachers or students already engaged in a learning group may accept incoming invitations from supervisors or advisors, whose role involves observation, grading, assessing progress and/or other functions related to the learning process.

In some embodiments, connector user interface may be configured to enable user participants of the learning group to drop out of the group at will and rejoin it mid-session.

### User Learning Interface

The role of the disclosed apparatus is to enable teaching process through providing a learning group interface to each participating user.

The teaching session is normally delivered by a user who assumes a teacher role. In some embodiments, this role is assumed by an individual with higher level of proficiency and/or combination of teaching skills and qualifications. In other embodiments, users may choose to rotate or alternate the teaching role or appoint a person to this role based on some other rule or motivation.

User interface available to each user comprises a set of information outputs and controls defined by the user role in the learning process. It is generally assumed that at least one of the users in each learning pair or learning group assumes teacher role. The teacher “teaches” by exercising control over the pace and flow of information through other users' (students) learning group interfaces.

In embodiments where subject matter is learning foreign languages, communication in different languages between users is enabled by means of prepared communication scenarios or scripts adapted to facilitate studying a foreign language. In embodiments where subject matter is not learning a language, the scenarios are built for appropriate interactive exercises facilitating learning the subject matter skill.

The prepared communication scenarios are delivered through the combination of three components for the users': (i) real-time audio-visual communication between the users, (ii) displays of text visual symbols reflecting a scenario of topics in stages used for communication in foreign languages understood by the users, and (iii) interactive text messaging between the users.

This combination of interactions is supported by the user interface organized as shown in FIG. 3 or in an equivalent structure. The learning interface presented to each user in the group comprises an incoming video field 301, an outgoing video field 302, a correspondence history field 303 showing the record of messages sent and received by the user, a field to enter text message 304, an information slide 305, a field comprising an image or video clip corresponding to the current slide information 306, and a field 307 which enables managing the training process.

Particular topic scripts are prepared as sequences of information slides like the information slide 305 shown in FIG. 3.

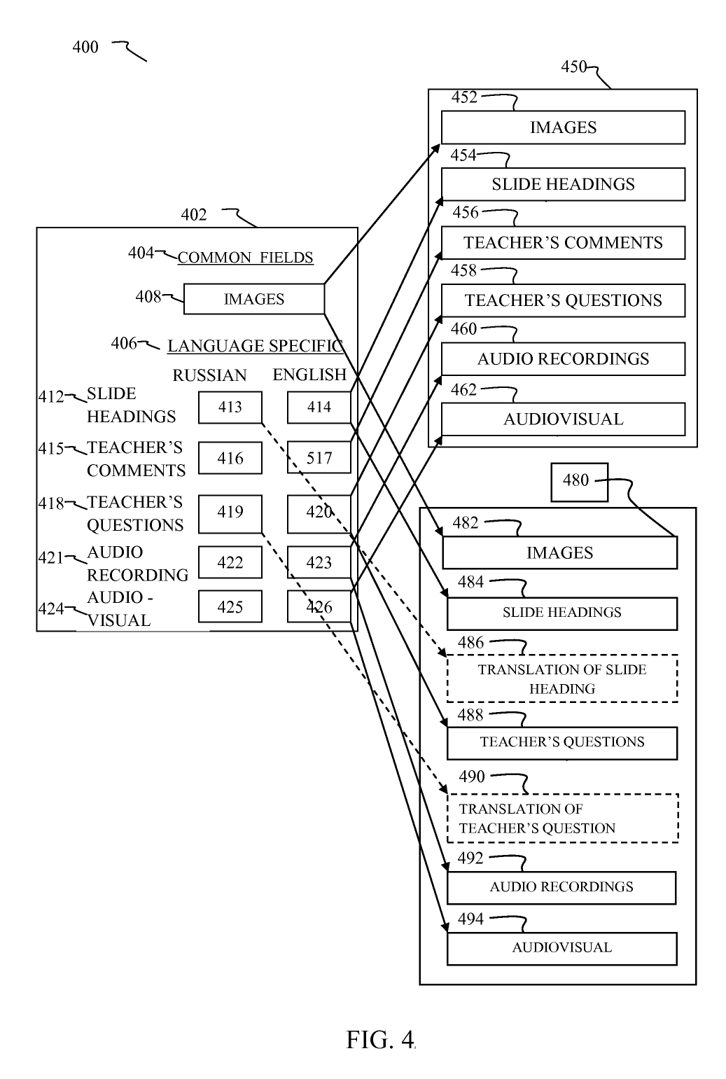

The apparatus is adapted to store content of each slide in a variety of languages mastered by the users, and to deliver it to every user based on his role and the languages they master, as illustrated in the example of FIG. 4.

In this embodiment, the scenario slide supports learning English for Russian speakers. The goal is to present part of the information pertaining to the slide topic to the Russian speaking learners of English in their native Russian. The information in the slide database entry 400 in a script database (“slide description” hereinafter) is subdivided into common fields 404, comprising image fields 408, and language specific fields 406, comprising slide headings 412, teacher's comments 415, teachers questions 418, audio recordings 421 and video 425 pertaining to the subject matter of the script. It is to be understood that in other embodiments slide descriptions may contain translations and equivalents in a number of different languages, least the composition of a learning group be restricted to speakers of a single language.

The content of slide headings 414, teacher's comments 417, teachers questions 420, audio recordings 423 and audiovisual programming 425 in English are transmitted directly into respective fields 452,454, 456, 458, 460 and 462 at the slide for the teacher of English 450 displayed in field 405 of the user learning interface of the user who had assumed a teacher role. Likewise, slide headings 414, teacher's questions 420, audio recordings 423 and audiovisual programming 425 in English are transmitted into respective fields 484, 488, 492, and 494 in the student learning interface 480. Besides that, in some embodiments of the current disclosure, a student user or a teacher user, receives an option to activate tips. When tips option is activated, slide headings stored in field 413 and teacher's questions stored in field 419 of the slide description in Russian language are transmitted for the student user viewing in fields 486 and 490 respectively. These optional fields are shown in the diagram in FIG. 4 with dashed line borders.

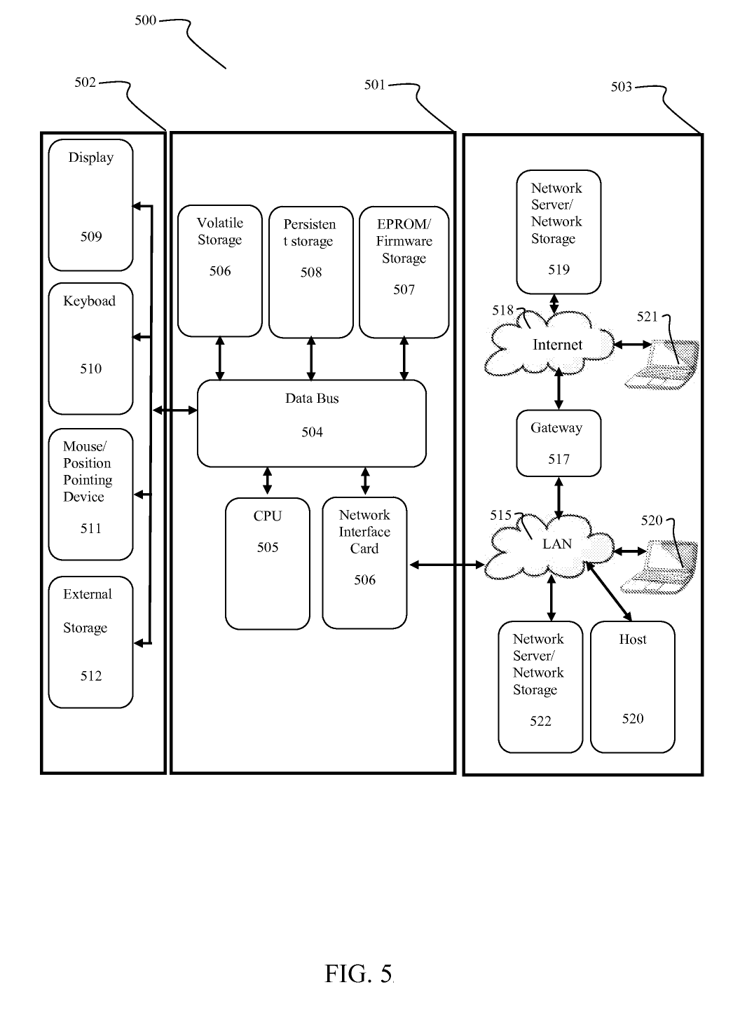

FIG. 5 is a block diagram that illustrates an exemplary embodiment of a computer system 700 representing the hardware components of the apparatus hereby disclosed. The system 500 includes a computer platform 501, peripheral devices 502 and network resources 503.

The computer platform 501 may include a data bus 507 or other communication mechanism for communicating information across and among various parts of the computer platform 501, and a processor 505 coupled with bus 704 for processing information and performing other computational and control tasks.

Computer platform 701 also includes a volatile storage 506, such as a random access memory (RAM) or other dynamic storage device, coupled to bus 504 for storing various information as well as instructions to be executed by processor 505, including the software application for proxy detection described above. The volatile storage 506 also may be used for storing temporary variables or other intermediate information during execution of instructions by processor 505.

Computer platform 501 may further include a read only memory (ROM or EPROM) 507 or other static storage device coupled to bus 504 for storing static information and instructions for processor 505, such as basic input-output system (BIOS), as well as various system configuration parameters. A persistent storage device 508, such as a magnetic disk, optical disk, or solid-state flash memory device is provided and coupled to bus 504 for storing information and instructions.

Computer platform 501 may be coupled via bus 404 to a touch-sensitive display 509, such as a cathode ray tube (CRT), plasma display, a liquid crystal display (LCD), or an organic light emitting device display (OLED) for displaying information to a system administrator or user of the computer platform 501. An input device 510, including alphanumeric and other keys, is coupled to bus 507 for communicating information and command selections to processor 505. Another type of user input device is cursor control device 511, such as a mouse, a trackball, or cursor direction keys for communicating direction information and command selections to processor 505 and for controlling cursor movement on touch-sensitive display 509. This input device typically has two degrees of freedom in two axes, a first axis (e.g., x) and a second axis (e.g., y), that allows the device to specify positions in a plane. To detect user's gestures, the display 509 may incorporate a touchscreen interface configured to detect user's tactile events and send information on the detected events to the processor 505 via the bus 504.

An external storage device 512 may be coupled to the computer platform 501 via bus 504 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 508. Volatile media includes dynamic memory, such as volatile storage 506.

Common forms of computer-readable media include, for example, a floppy disk, a flexible disk, hard disk, magnetic tape, or any other magnetic medium, a CDROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 504. The bus 504 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 504. Communication interface 513 provides a two-way data communication coupling to a network link 514 that is coupled to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 514 typically provides data communication through one or more networks to other network resources. For example, network link 514 may provide a connection through local network 515 to a host computer 516, or a network storage/server 522. Additionally or alternatively, the network link 514 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 514 and through communication interface 513, which carry the digital data to and from computer platform 501, are exemplary forms of carrier waves transporting the information. Computer platform 501 can send messages and receive data, including program code, through the variety of network(s) including Internet 518 and LAN 515, network link 515 and communication interface 513. In the Internet example, when the system 501 acts as a network server, it might transmit a requested code or data for an application program running on client(s) 520 and/or 521 through the

Internet 518, gateway/firewall 517, local area network 515 and communication interface 513. Similarly, it may receive code from other network resources. The received code may be executed by processor 505 as it is received, and/or stored in persistent or volatile storage devices 508 and 506, respectively, or other non-volatile storage for later execution.

Finally, it should be understood that processes and techniques described herein are not inherently related to any particular hardware apparatus and may be implemented by any suitable combination of components. Further, various types of general purpose devices may be used in accordance with the teachings described herein. It may also prove advantageous to construct specialized apparatus to perform the method steps described herein. The present apparatus has been discloseded in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for the analysis of user activity and preparation of the data for a music recommender in a social network. It is intended that the specification and examples be considered as exemplary only, with a true scope and spirit of the invention being indicated by the following claims.

What is claimed is:

1. An apparatus comprising:
a computer-readable storage medium comprising a program code encoded therein, wherein the program code is configured to be executed by a processor, the program code comprises a plurality of executable instructions for teaching a subject matter, and the executable instructions comprise:
forming a first user connector interface, comprising a field enabling the first user to select a first participant role;
forming a second user connector interface, comprising a field enabling a second user to select a second participant role;
generating a field comprised within the first user connector interface indicating the second user identity and the second participant role selected by the second user;
forming a spontaneous group interface accessible to the first user;
enabling the first user to invite the second user to join the spontaneous group interface;
indicating second user connectedness status in the spontaneous group interface; enabling the second user to generate a response chosen from the group comprising a consent or a rejection to the first user invitation, the invitation after being issued by the first user before the response is obtained being held pending;
obtaining the second user consent to the first user invitation, and generating a first learning group interface accessible to the first user and a second learning group interface accessible to the second user upon obtaining the second user consent.

2. The apparatus of claim 1, wherein the subject matter is a language.

3. The apparatus of claim 1, wherein the subject matter is a human language.

4. The apparatus of claim 1, wherein the participant role can be selected from a group comprising “a student” and “a teacher”, or equivalents thereof

5. The apparatus of claim 2, wherein the group comprises a “supervisor” role.

6. The apparatus of claim 4, wherein the first user connector interface or the second user connector interface comprises an indicator of participant proficiency level.

7. The apparatus of claim 4, further containing a step of enabling the first user to invite a third user after the first user invitation to the second user has been issued but before the second user consent is obtained.

8. The apparatus of claim 4, wherein the first user connector interface comprises a field indicating a current first user credit.

9. The apparatus of claim 4, wherein the first user connector interface comprises a field indicating the number of pending outgoing invitations.

10. The apparatus of claim 4, wherein the second user connector interface comprises a field indicating the number of pending incoming invitations.

11. The apparatus of claim 9 or 10, wherein the field indicating the number of pending outcoming or incoming invitations is clickable to display fields with user information for each pending invitation.

12. An apparatus comprising:
a computer-readable storage medium comprising a program code encoded therein, wherein the program code is configured to be executed by a processor in connection with a network interface card, a display and a memory, the program code comprises a plurality of executable instructions for teaching a subject matter, and the executable instructions comprise:
forming a teacher user interface and a student user interface comprising:
an incoming video portion;
an outgoing video portion;
a correspondence history portion;
a field to enter text message portion;
an information slide portion;
an image or video clip corresponding to the current slide information portion; and
a field to manage training process portion.

13. The apparatus of claim 12, wherein the computer-readable storage medium comprises a plurality of database entries, adapted to store a script for learning the subject matter in the form of slide descriptions which can be displayed in the teacher user interface information slide portion and in the student user interface information slide portion.

14. The apparatus of claim 13, wherein the subject matter is a foreign language.

15. The apparatus of claim 14, wherein each slide description comprises:
a pointer to a sequence of slide images;
a pointer to a first slide heading in and a pointer to a second slide heading, the a first slide heading written in a teacher language, the a second slide heading written in a student language, wherein the second heading is a translation of the first heading from the teacher language into the student language;
a pointer to a teacher user comments, adapted to store information in the teacher's language;
a pointer to a first teacher's questions field, adapted to store or enter textual information in the teacher's language, and a pointer to the second teacher's questions field, adapted to store or enter textual information in the student's language;
a pointer to an audio recording field, adapted to store audio content in the teacher's language, and
a pointer to an audio-visual field, adapted to store audiovisual content in the teacher's language.

16. The apparatus of claim 15, wherein: the user teacher interface comprises the information slide section, comprising:
a teacher image field adapted to display the sequence of slide images read out from the slide description;
a teacher slide headings field adapted to display the first slide heading read out from the slide description;
a teacher's comments field adapted to display the teacher user comments read out from the slide description;
a teacher's questions field adapted to display the textual information stored or entered in the first teacher's questions field read out from the slide description;
a teacher's audio field adapted to reproduce audio content stored in the audio recording field of the slide description, and
a teacher's audiovisual field adapted to reproduce audiovisual content in the audio-visual field read out from the slide description.

17. The apparatus of claim 16, wherein: the user student interface comprises the information slide section, comprising:
a student image field adapted to display the sequence of slide images stored in the slide description;
a first student slide headings field adapted to display the first slide heading;
a first questions field adapted to display the textual information stored or entered in the first teacher's questions field;
a student's audio field adapted to reproduce audio content stored in the audio recording field, and
a student's audiovisual field adapted to reproduce audiovisual content in the audio-visual field.

18. The apparatus of claim 16, further comprising:
a second student slide headings field, the field capable of being activated to display the second slide heading.

19. The apparatus of claim 16, further comprising:
a second questions field, the field capable of being activated to display the textual information stored or entered in the second teacher's questions field.
